(19) United States
(12) Patent Application Publication
(10) Pub. No.: US 2017/0280090 A1
(43) Pub. Date: Sep. 28, 2017

(54) BINOCULAR DISPLAY AND METHOD FOR DISPLAYING IMAGES

(71) Applicant: Elsewhere, LLC, Oakland, CA (US)

(72) Inventor: Aza Raskin, Oakland, CA (US)

(21) Appl. No.: 15/469,377

(22) Filed: Mar. 24, 2017

Related U.S. Application Data
(60) Provisional application No. 62/313,040, filed on Mar. 24, 2016.
(60) Provisional application No. 62/434,812, filed on Dec. 15, 2016.

(51) Int. Cl. H04N 5/445; G06T 7/11; G06T 5/50

(52) U.S. Cl. CPC H04N 5/44504; G06T 5/50; G06T 7/11; G06T 2207/20221; G06T 2207/20216; G06T 2207/10016

(57) ABSTRACT

A method for displaying images, including: receiving an input video; selecting a primary frame and a delayed frame from the input video; generating a generated frame by mixing the primary frame with the delayed frame in a spatially non-uniform manner; generating a first output video including the generated frame; generating a second output video based on the input video; and displaying the first and second output videos to a viewer. A method for displaying images, including: controlling a camera to sample an input video; generating an output frame by mixing a plurality of frames of the input video in a spatially non-uniform manner; generating a first output video including the output frame; generating a second output video based on the input video; and controlling a display unit to concurrently display the first and second output videos to a viewer.

### CROSS-REFERENCE TO RELATED APPLICATIONS

This application claims the benefit of U.S. Provisional Application Ser. No. 62/313,040, filed on 24 Mar. 2016, and U.S. Provisional Application Ser. No. 62/434,812, filed on 15 Dec. 2016, both of which are incorporated in their entirety by this reference.

### TECHNICAL FIELD

This invention relates generally to the field of image display, and more specifically to a new and useful system and method in the binocular image display field.

### BACKGROUND

A pseudo-stereoscopic effect can be created by displaying two different frames from the same video to a viewer in a binocular manner. However, the pseudo-stereoscopic effect achieved in this manner often produces perceptions of depth incongruous with reality or the perceived scene. Thus, there is a need in the image display field to create an enhanced method for pseudo-stereoscopic video generation.

### BRIEF DESCRIPTION OF THE FIGURES

FIG. 1 is a schematic representation of a first embodiment of the method for displaying images;

FIGS. 2A-2B are schematic representations of processes for selecting frames in a first and second variation of the method, respectively;

FIGS. 3A-3B are schematic representations of a first and second specific example, respectively, of elements of the method;

FIGS. 4A-4C are schematic representations of a first, second, and third example, respectively, of an element of the first variation;

FIG. 5 is a schematic representation of an element of a fourth variation of the method;

FIG. 6 is a schematic representation of a specific example of an element of the method;

FIG. 7 is a flowchart diagram of the method;

FIG. 8A is a schematic representation of an embodiment of the binocular display; and

FIG. 8B is a perspective view of a variation of the binocular display.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method for Displaying Images

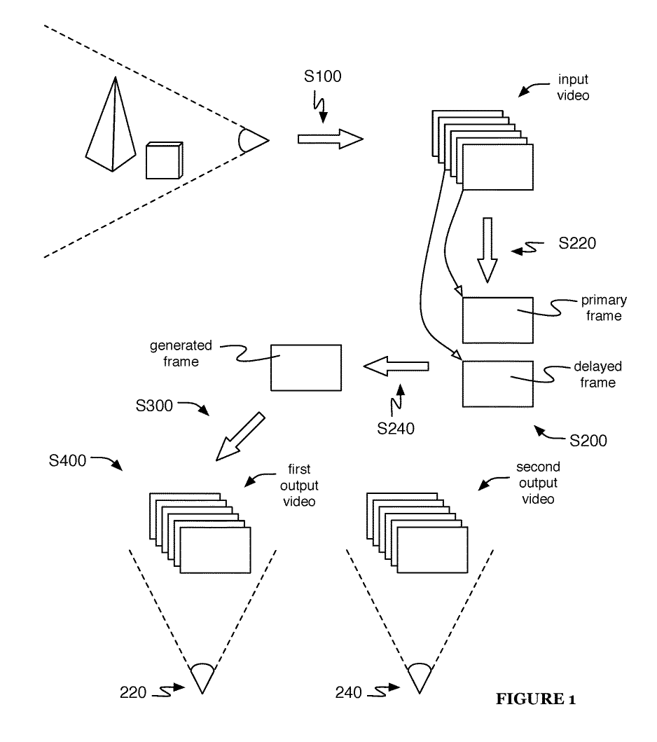

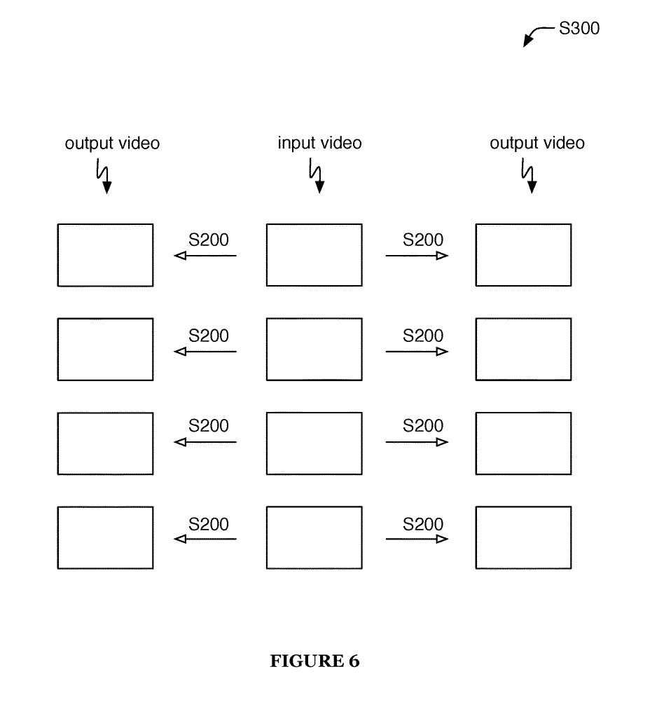

A method for displaying images can include: capturing an input video in Block S100; generating a generated frame by mixing two frames of the input video in Block S200; generating one or more output videos in Block S300; and displaying the output videos, each to a different eye of a viewer, in Block S400 (e.g., as shown in FIGS. 1 and 7). The method functions to enhance the sense of depth perceived by the viewer. The generated frame is preferably generated in such a way as to help create or enhance a stereoscopic or pseudo-stereoscopic effect.

Block S100 recites capturing a set of input information, preferably including an input video. Block S100 functions to provide the input video and other relevant information for use in the method. Block S100 can be performed using a single video camera, two video cameras that are arranged to capture stereoscopic images, by many video cameras, an array of still-image cameras, or any other suitable collection of image capture devices. The camera or cameras preferably use digital image sensors, such as charge-coupled device or active-pixel image sensors, but alternately could use any suitable sensor or imaging medium for capturing the input video or any other images captured in Block S100. The input video is preferably continuous video footage (e.g., a sequence of frames with a regular frame rate, such as 16 fps, 30 fps, 60 fps, 10-100 fps, etc.), but can additionally or alternatively include any suitable sequence of image signals. The sampling rate for a given camera can be constant, dynamically adjusted over time (e.g., adjusted according to a predetermined schedule, adjusted as a function of camera motion, object motion, etc.), or otherwise variable over time. The sampling rate between cameras can be the same, be different (e.g., a first camera samples at a faster rate than a second camera, at a proportional rate to the second camera, etc.), or be otherwise related.

The set of input information can additionally or alternatively include additional information (e.g., other than video footage). In some embodiments, the additional information can be captured at the same time as the capture of the input video, be captured at a different time, be captured both during the capture of the input video and at a different time, or be captured at any other suitable time. The additional information can be captured by the camera(s), auxiliary systems physically mounted to the cameras, auxiliary systems synchronized or otherwise associated with the cameras, or any other suitable system. Examples of auxiliary systems include: user devices (e.g., smartphones, smart watches, wearable sensors, etc.), external sensors (e.g, cameras, microphones), or any other suitable system.

In a first variation, the additional information can include optical information (e.g., additional captured images or video, ambient light metrics such as intensity, etc.). In a second variation, the additional information can include spatiotemporal information. The spatiotemporal information can include inertial measurements such as measurements from an accelerometer, gyroscope, magnetometer, IMU, altimeter, or other inertial sensor. Alternately, the spatiotemporal information can include information about the time of day, and/or about one or more subject positions. Information about subject positions can include the position (e.g., current, past, anticipated, etc.) of: the viewer, an element of a system used to perform the method, an object depicted in a frame of the input video or another captured image, or any other suitable object. The spatiotemporal information can be obtained by an absolute positioning system, such as GPS; by a reflective technique such as optical rangefinding, radar, or sonar; by triangulation or trilateration; or in any other suitable manner. In a third variation, the additional information can include audio information, possibly including information captured by a microphone in the vicinity of the viewer or the video capture device. However, the additional information can include: information obtained from the internet; preset information; random information; generated noise information, such as a value noise signal or a gradient noise signal like Perlin noise or Simplex noise; and/or any other suitable information.

Additionally or alternatively, the additional information can be related to one or more people (e.g., the viewer, other people, etc.). In a first variation, the information can be based on behaviors of the people, such as: selections made by the people; directions in which the people look, speak, point, or indicate (e.g., as determined from the input information, auxiliary information, etc.); communication from the people, possibly including speech, writing, or other language-based communication or facial expressions or other non-verbal communication; or motions made or forces applied by the people. In a second variation, the information can be based on attributes of the people, such as: historical information (e.g., education history, work history, consumer history, social networking history, or relationship history); social characteristics (e.g., friends, colleagues, business contacts, or followers); physical characteristics (e.g., appearance, height, weight, or clothing type); user preferences; personality traits (e.g., learned, received from the user); intelligence metrics; and/or any other suitable user attributes. In a third variation, the information can be otherwise relevant to the people, such as financial information, order shipping information, weather information, or information about news or current events.

However, the additional information can include any other suitable information, and can include any combination of the options presented for any or all of these embodiments. In a first specific example, the input video is captured by a single digital video camera, and the additional information includes the time of day during the video capture. In a second specific example, the input video is captured by two digital video cameras arranged to capture stereoscopic video, and the additional information includes: inter-camera distance (e.g., baseline); preset viewer preferences; acceleration and orientation with respect to gravity of the video camera during the video capture; and direction of the viewer's eyes during the video display.

Block S200 functions to generate one or more videos (or other sequences of images) for display. S200 preferably includes selecting a primary frame and a delayed frame from the input video in Block S220 and generating a generated frame by mixing the primary frame with the delayed frame in a spatially non-uniform manner in Block S240. Block S200 preferably generates one or more frames that can help create or enhance a stereoscopic or pseudo-stereoscopic effect. In some embodiments, one or more of the primary frame, the delayed frame, and the generated frame can be modified by image modification techniques. These image modification techniques can include modifications that can be implemented as a pixel shader, such as sharpening; edge enhancement; alteration of one or more appearance parameters such as color, saturation, or lightness; geometrical transformations such as stretches, pinches, or swirls; warping; blending; offsetting (e.g., horizontally, vertically, etc.); adjusting identified object sizes, shapes, locations, or other parameters; and/or any other suitable modification. The applied image modification technique can be predetermined, dynamically determined (e.g., using a neural network, lookup table, classification, regression, heuristics, etc.), or otherwise determined.

Block S220 functions to select two frames (e.g., a primary frame and a delayed frame) appropriate for mixing from the input video. The frames can be selected based on the respective sampling times (or recordation times), the respective frame content (e.g., objects in each frame, pixel values in each frame), the respective processing times, or based on any other suitable parameter value. The frames can be selected using: predetermined set of rules, a neural network (e.g., CNN), heuristics, classification, regression, or otherwise selected. Block S220 can include selecting a primary frame and selecting a delayed frame, but can additionally or alternatively include any other suitable process.

Selecting the primary frame functions to determine a frame for processing (e.g., mixing, adjusting). The primary frame can be the most recent frame suitable for mixing at a point in time or be any other suitable frame. For example, for a given point in time, the primary frame can be the most recently captured frame of a set of frames; be the frame that, of the set of frames, has undergone some preprocessing most recently; be the frame that, of the set of frames, has been most recently received at a processor programmed to perform the spatially non-uniform mixing; or be any other suitable frame or set thereof. The set of frames can include all of the frames of the input video, can include only a subset of those frames, and/or can include frames of multiple input videos (e.g., different streams, composited frames, mosaicked frames, etc.). The subset can be selected based on characteristics of the frames, or based on other information.

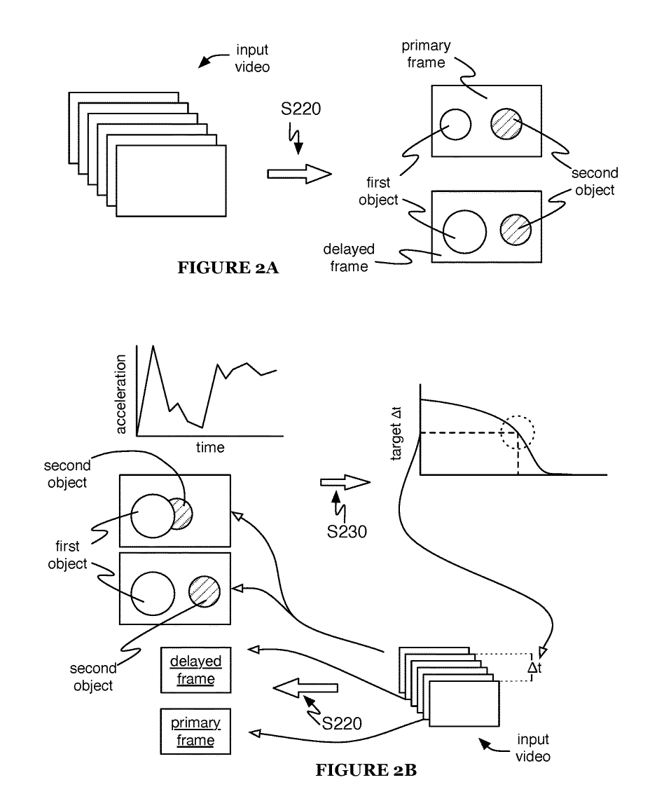

Selecting the delayed frame functions to determine a second frame for processing. Properties of the delayed frame (e.g., pixel values, object positions, etc.) are preferably used to adjust properties of the primary frame (e.g., corresponding properties, different properties), but the delayed frame can be merged with the primary frame, mosaicked with the primary frame, blended with the primary frame, used as a mask for the primary frame, or otherwise processed. In a first variation, the delayed frame is selected such that it depicts substantially the same objects as the primary frame (e.g., as shown in FIG. 2A). This selection can be based on analysis of the selected frames, or based on measurement of the motion of any of the video capture devices or the objects depicted in the frame, or based on the time elapsed between the capture of the selected frames, or based on any other suitable basis. The selection can be made based on knowledge that the two frames depict substantially the same objects, or based on an estimate to that effect, or alternately the selection can be made without any basis. Where the primary frame is one of a first frame and a second frame and the delayed frame is the other of those frames, the first frame can depict many of the same objects as the second frame (e.g., greater than a threshold fraction of all the objects depicted in the second frame, such as 95%, 80%, 60%, 100-50%, etc.). Alternately, the first frame can depict many of the large objects depicted in the second frame (e.g., objects that occupy more than a threshold fraction of the area of the second frame, such as 2%, 10%, 20%, 5-25%, etc.). In another alternative, the first frame can depict many of the objects depicted in a central region of the second frame, such as the central 50%, 80%, or 95% area of the second frame. Objects can be all objects depicted by a frame, can be objects identified by an image segmentation process performed on the frame, and/or can be determined in any other suitable manner.

In a second variation, the delayed frame is a frame recorded a predetermined time period (delay time) before and/or after the primary frame (e.g., wherein the respective timestamps are separated by a predetermined time duration; wherein the primary and delayed frames are separated by a predetermined number of intervening frames, etc.). In this variation, Block S220 further recites determining a delay time defined by the difference in time between the capture of the primary frame and the capture of the delayed frame. The delay time can be predetermined, dynamically determined (e.g., manually, automatically), or otherwise determined. In one embodiment (e.g., as shown in FIG. 2B), determining the delay time includes selecting a target delay time based on the input information in Block S230, wherein the delayed frame is selected such that the delay time is substantially equal to the target delay time. In a first variation, given a specific primary frame, the delayed frame can be: selected from a set of possible delayed frames to minimize the difference between the delay time and the target delay time; selected to minimize that difference while ensuring that the delay time is less than the target delay time, or alternately more than the target delay time; selected such that the difference is no greater than a maximum limit; or in any other suitable manner. The set of possible delayed frames can be all the frames of the input video; or alternately can be only a subset of those frames. The subset can be selected randomly, based on analysis of the frames (e.g., frames including a predetermined object, frames satisfying any other suitable set of conditions, etc.), based on the primary frame (e.g., be frames within a predetermined time of the primary frame recordation time), based on other input information, or be based on any other suitable basis. In an alternate variation, given a specific delayed frame, the primary frame can be selected in any manner analogous to the options of the first variation for selecting a delayed frame, or in any other suitable manner.

In a second embodiment, determining the delay time includes selecting a target delay time S230 based on spatiotemporal information, such as position, velocity, acceleration, or orientation of a video capture device, a display, the viewer, an object depicted in the input video or other captured image, or any other suitable object; or based on time of day during the capture of the input video. For example, the target delay time can change (e.g., inversely, proportionally) based on the magnitude of acceleration of a camera or depicted object. In a specific example, the target delay is reduced in response to large magnitude acceleration.

In a third embodiment, determining the delay time includes selecting a target delay time S230 based on information derived from the input video or from other captured images, such appearance parameters or information based on image segmentation. Appearance parameters can include: hue, lightness, brightness, chroma, colorfulness, saturation, variance, gradients, spatiotemporal parameter value distributions, moments (e.g., mean, variance, dispersion, mean square value or average energy, entropy, skewness, kurtosis), quality metrics (e.g., PSNR, MSE, SSIM, etc.), and/or any other suitable appearance parameters. For example, the target delay time can change based on the average lightness of a region of an image, possibly being reduced for high average values of lightness in the region. Information based on image segmentation can include: edge detection information; region detection information; or object recognition information such as object identification, estimated object motion (e.g., perceived motion data, such as data indicative of viewer motion, surrounding object motion, etc.), facial recognition information, background/foreground segmentation, and/or any other suitable processing method. For example, the target delay time can change based on an estimate of the speed of an object, such as the brightest object, fastest-moving object, or closest object to a camera; possibly being reduced when the estimated speed of the object is high.

In a fourth embodiment, determining the delay time includes selecting a target delay time S230 based on any other input information, such as other optical information, audio information, or any other suitable information captured in Block S100. Further, the target delay time can be selected S230 based on any suitable combination of information, including information in the set of input information and information not in that set.

Block S240 functions to combine information from two captured frames into a single generated frame. In a first variation, the mixing S240 can be performed on a regional basis, where the regions can be pixels, quadrants, rings, rectangles, or any other suitable regions. The two frames can be directly overlaid, with a pair of corresponding pixels (e.g., colocated pixels), one pixel from each frame, being mixed to generate the corresponding pixel of the generated frame. Additionally or alternatively, one or both of the frames can be translated, scaled, cropped, stretched, flipped, rotated, pinched, swirled, or otherwise transformed before being overlaid. In a second variation, mixing S240 can be performed on objects or regions identified by image segmentation. In a third variation, the mixing S240 can be performed in the frequency domain, such as mixing the result of the discrete Fourier transform of a region of one frame with a signal derived from the other frame, possibly performing a discrete Fourier transform on the result of the mixing. However, the information can be otherwise combined between the frames.

The spatially non-uniform manner of mixing can be specified by a control signal in Block S250. The control signal can be represented by an array of values, and mixing the two frames S240 can include a masked blending process wherein the control signal includes and/or serves as the mask (e.g., an array corresponding to the pixel array of the frame, wherein each entry in the array includes a blending value, such as a weighting for weighted averaging). The masked blending can be performed using any suitable blending mode, possibly including: commutative modes such as additive modes or multiplicative modes; anticommutative modes such as subtractive modes; other arithmetic modes such as division-based modes; or modes in which a first set of appearance parameters are derived, in part or in whole, from the primary frame, and a second set of appearance parameters different from the first set are derived, in part or in whole, from the delayed frame, such as a color dodge, luminosity blend, or lightening blend.

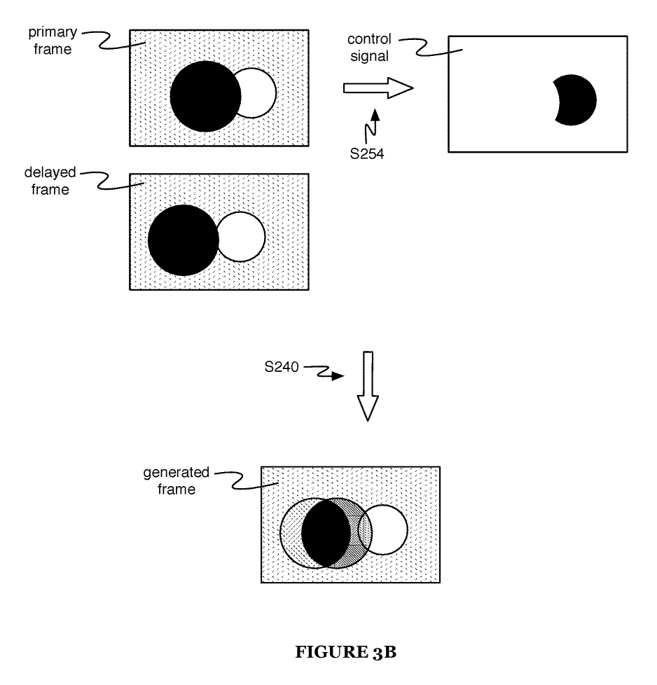

In one variation, the control signal is derived from the input video. An image segmentation process can be performed on a frame of the input video, and the control signal can be derived from the result of that image segmentation process in Block S252 (e.g., as shown in FIG. 4A). For example, the control signal can be based on: edge detection information; region detection information; object recognition information such as object identification, estimated object motion, or facial recognition information; display recognition; or any other suitable information derived from image segmentation. In a first specific example, the control signal can specify a high degree of mixing in a region identified as depicting an object of interest. In a second specific example, the control signal can specify that mixing not occur outside a region identified as depicting an active video display such as a television showing a television show.

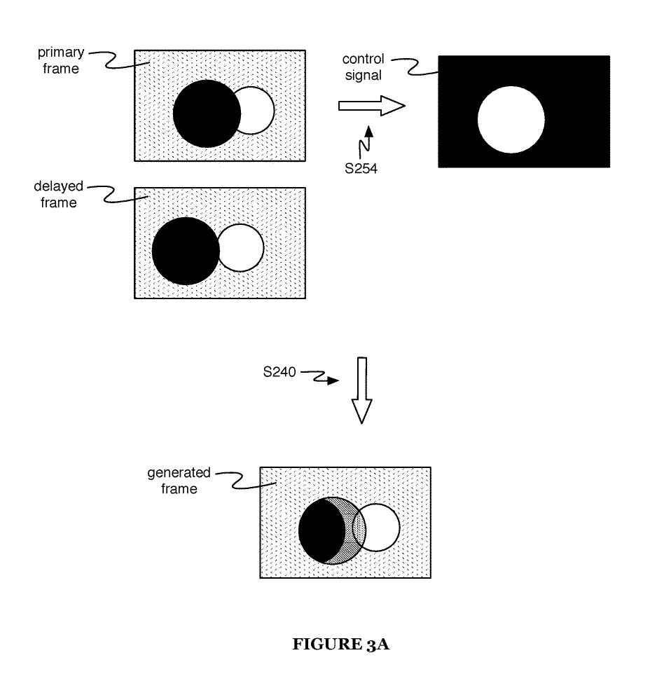

The control signal can be an image signal with the same dimensions as one or more frames of the input video, and each pixel of the control signal can be derived from the corresponding pixel values (e.g., values, such as red, green, and blue values, of the corresponding pixel) of the frames of the input video in Block S254 (e.g., as shown in FIGS. 3A, 3B, and 4B). For example, each pixel of the control signal can be based on one or more appearance parameters of the corresponding pixel, such as: hue, lightness, brightness, chroma, colorfulness, saturation, or any other suitable appearance parameters. In a first example, the control signal can take on high values at pixels for which the corresponding pixel has low lightness (e.g., as shown in FIGS. 3A and 3B). In a second example, the control signal can take on high values at pixels for which the corresponding pixel has high lightness. In a third example, the control signal can be derived from the difference between the appearance parameters of the corresponding pixel of a first and second frame of the input video. In this specific example, the first frame and second frame are consecutive frames, and the control signal is zero (e.g., no mixing) when the difference between the brightness of the corresponding pixel in the two frames is greater than a threshold value (e.g., 10%, 20%, 50%, 75%, 10-35%, 30-75%, or 70-90% of the maximum brightness) and non-zero (e.g., 0.001, corresponding to 0.1% mixing of the first frame into the second, 0.0025, 0.005, 0.01, 0.1, 0.001-0.05, etc.) otherwise. In a fourth example, the control signal value for a given pixel position can be determined based on the parameter value of the primary frame's corresponding pixel; the parameter value of the delayed frame's corresponding pixel; the difference in the parameter values between the primary frame and delayed frame's corresponding pixels; or be otherwise determined. In a specific example, determining the control signal includes: determining a blending mask including a plurality of pixels, wherein a pixel value of each pixel of the blending mask is determined based on a lightness of a corresponding pixel value of a frame of the input video. The control signal can be used to determine a weighting (e.g., equal to the control signal, as a function of the control signal, etc.) for weighted averaging of the frames on a pixel-by-pixel basis. However, the control signal can be used in any other suitable manner.

In a second variation, the control signal is derived from a characteristic of a person or a group of people. The person can be the viewer, or can be a person depicted in the input video or another captured image, or can be a person in visual range of an object depicted in the input video or another captured image, or can be any other person. In some examples, the control signal can be derived based on the direction of the eyes of the person in Block S256 (e.g., as shown in FIG. 4C). In a first specific example, a degree of blending can be reduced in a region at which the viewer is looking. In a second specific example, the degree of blending can be increased in a region depicting an object at which many people are looking.

In alternate examples, the characteristic can be another behavior of the person, such as: selections made by the person; directions in which the person speaks, points, or indicates; communication from the person, possibly including speech, writing, or other language-based communication or facial expressions or other non-verbal communication; or motions made or forces applied by the person. In further examples, the characteristic can be one or more attributes of the person, possibly including historical information such as education history, work history, consumer history, or relationship history; social characteristics such as friends, colleagues, business contacts, or followers; physical characteristics such as appearance, height, weight, or clothing type; or mental characteristics such as preferences, personality traits, or intelligence metrics. In a specific example, a degree of blending in a region depicting a person with whom the viewer is communicating can be affected by the nature of the conversation.

In a third variation, the control signal can be derived from a randomly generated signal, a gradient noise signal, a value noise signal, another procedurally generated noise signal, or any other similarly generated signal. For example, the control signal can be an image signal that specifies a degree of blending on a pixel basis, and the image representation of the control signal can be a variant of Simplex noise.

In a fourth variation, the control signal can be based on captured images other than the input video; based on other optical information; based on audio information; based on regions in which virtual objects will be inserted into the generated frame; based on a sequence generated by a user; based on a pre-recorded track; or based on any other suitable information. However, the control signal can be a function, a set of values selected from a lookup table, or be based on any suitable combination of information.

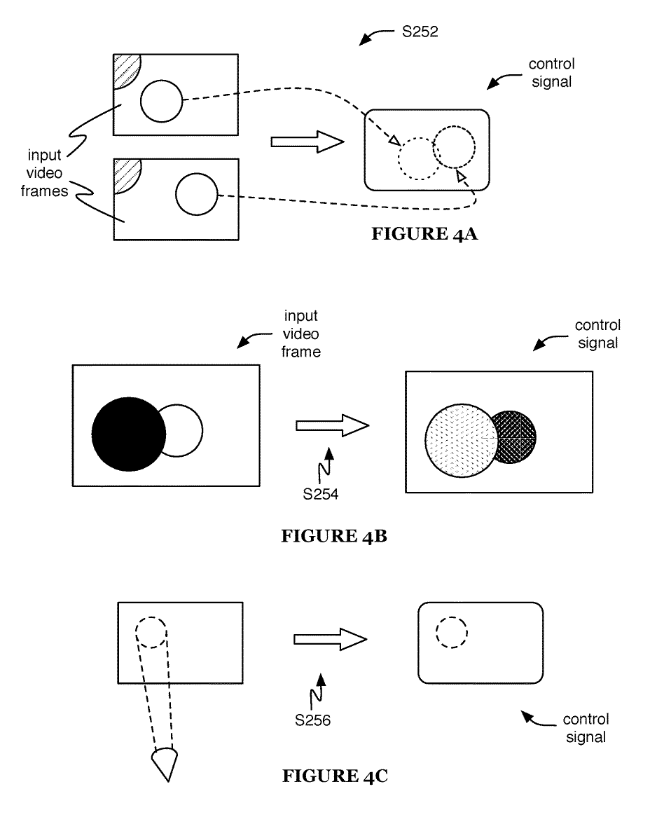

Block 200 can optionally include inserting renderings of a virtual object into frames to be displayed to the viewer in Block S260 (e.g., as shown in FIG. 5). Block S260 recites: inserting a first rendered view of the virtual object into the generated frame; inserting a second rendered view of the virtual object into a second frame; and displaying the generated frame to the first eye of the viewer at substantially the same time as displaying the second frame to the second eye of the viewer; wherein the first and second rendered views depict the virtual object from different viewpoints. Block S260 function to augment the displayed images with the appearance of the virtual object. In some variations, the two views are rendered from viewpoints that are horizontally separated by a typical human pupillary distance, such that the rendered views in the two displayed frames will create a stereoscopic effect when viewed in a binocular manner. However, S260 can be otherwise performed.

Block S200 can optionally include selecting one or more additional frames or other image signals to mix with the primary frame and delayed frame, or with the generated frame. This can include mixing a third frame from the input video with the generated frame, or mixing a frame from a second video with the primary frame and delayed frame, or any other suitable process of mixing more than two frames. However, additional frames can be otherwise selected.

Block S200 can optionally be performed such that some difference metric between the generated frame and a comparison frame is less than a maximum difference limit. The comparison frame can be a frame from the input video, such as the primary frame or the delayed frame; or a frame generated in a similar manner to the generated frame; or a frame that will be displayed to the user at the same time as the generated frame; or any other suitable frame. The difference metric can be based on a pixel-by-pixel comparison, or based on a comparison involving image segmentation, or based on any other suitable comparison.

Block S200 can be performed only once, or it can be repeated to produce multiple generated frames. It can be performed once for each frame of the input video or for a subset of those frames. Each performance can be performed as a different embodiment of Block S200.

Block S300 recites generating one or more output videos. The output videos, such as the first output video or second output video, are preferably generated based on the input video. An output video can be identical to the input video except that a frame (e.g., the primary frame, the delayed frame, a frame that was captured between the primary frame and the delayed frame, a frame that was captured at a time close to the capture of the primary frame or delayed frame, etc.) is replaced by the generated frame in Block S320. Alternately, the generated frame can be inserted between the above-mentioned frames or any other suitable frame in Block S340. In some variations, Block S200 is performed multiple times, and each of the resulting generated frames is inserted into the output video in the manner of Block S320 or Block S340. In alternate variations, Block S200 can be performed at least once for each frame of the input video (e.g., repeating some or all elements of Block S200, in the same manner or different manners, to generate a sequence of frames). In each of these iterations of Block S200, a different frame of a video, such as the input video, can be the primary frame, and the output video can be generated by replacing each primary frame with its complementary generated frame in Block S360. In one example, the primary frame for a first iteration of S300 can be used as the delayed frame for a subsequent iteration of S300. In this example, the subsequent iteration can use the raw primary frame of the first iteration, the processed primary frame (e.g., the generated frame) of the first iteration, or any other suitable version of the primary frame of the first iteration.

The first output video can be generated by the process of Block S360 and the second output video can be one of: the input video (e.g., raw video, compressed or downsampled video, etc.); a second input video captured at substantially the same time as the input video; a different output video generated by the process of Block S360; or any other suitable video. The different output video can be generated based on the input video, but use different embodiments of Block S200 than are used to generate the first output video; or it can be generated based on a second input video, using either the same or different embodiments of Block S200 as used to generate the first output video; or can be generated based on any other suitable video.

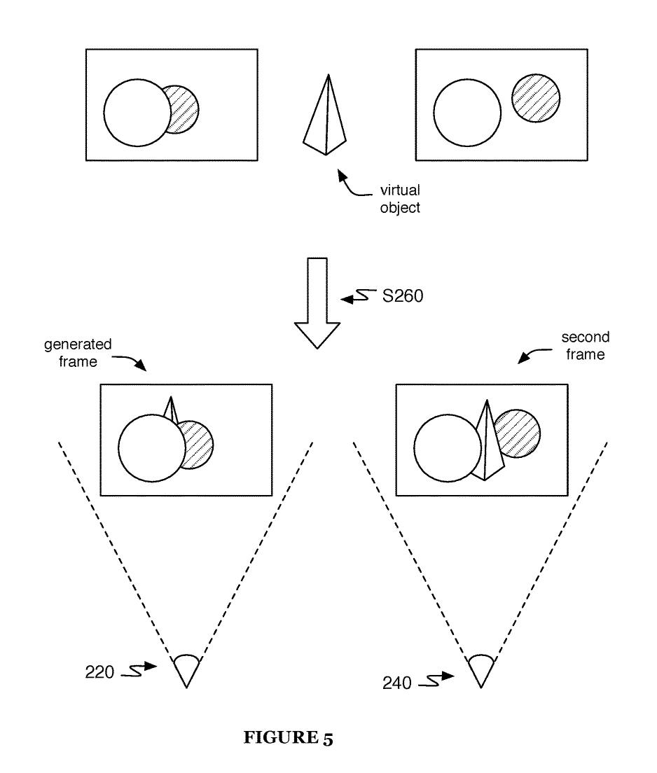

In a first specific example (e.g., as shown in FIG. 6), the second output video is generated based on the input video by the process of Block S360, using the same primary and delayed frames as for the generation of the first output video, but the mixing of the frames is performed in the opposite manner as for the first output video, such that regions that are predominantly based on the primary frame in a generated frame of the first output video are predominantly based on the delayed frame in the complementary generated frame of the second output video. In a second specific example, the second output video is generated based on a second input video by the process of Block S360, but using similar embodiments of Block S200 as are used to generate the complementary frames of the first output video.

In a specific example, S300 includes generating a generated frame (e.g., to be inserted into an output video). Generating the generated frame can include: for each pixel of the blending mask, determining a pixel value of a corresponding pixel of the generated frame by adjusting a corresponding pixel value of the primary frame with a corresponding pixel value of the delayed frame (e.g., averaging, subtracting, adding, or otherwise adjusting a weighted delayed frame's pixel value to the primary frame's pixel value) based on the pixel value of the pixel of the blending mask. However, the frames can be otherwise generated.

Block S400 recites displaying the output videos (e.g., the videos generated in Block S300), each to a different eye of the viewer. S400 preferably includes: displaying a first output video that includes the generated frame(s) to the first eye of the viewer (e.g., right eye, left eye); and displaying a second output video to the second eye of the viewer (e.g., opposing eye) at substantially the same time as the first output video is displayed. However, the output videos can be displayed in any other suitable spatiotemporal relationship. Block S400 functions to display videos to the viewer in a manner suitable for binocular viewing. The output videos are preferably displayed such that each eye can only view one of the videos, but can alternatively be displayed such that both videos are visible to one or both eyes, or such that the videos are displayed in the same region (or substantially the same region) as each other (e.g., substantially simultaneously, alternating frames, etc.).

One or more of the videos are preferably displayed in near-real time after video capture, but can alternatively be displayed asynchronously from video capture. For example, each generated frame is preferably displayed in near-real time after the capture of the corresponding primary frame from which it was generated (e.g., within a threshold time after the capture, such as 1 s, 0.1 s, 0.05 s, 0.001 s, etc.; such that the viewer perceives it as being displayed a substantially the same time as primary frame capture). This can function to enable use of the displayed videos for near-real time viewing and/or navigation of the viewer's surroundings (e.g., using the displayed videos as an “augmented reality” system).

Each complementary pair of frames of the output videos can be displayed as soon as the frames have been generated. Alternately, the pairs of frames can be displayed after some waiting period of less than one second, or can be displayed after a longer waiting period. In some variations, the pairs of frames are displayed soon after the capture of the primary frames from which they are generated, such that the viewer perceives the generated frames as being displayed at substantially the same time as the capture of the primary frames from which they are generated, or alternately perceives only a short delay between the capture and subsequent display.

Each frame can be displayed for an equal time interval, a variable time interval, a time interval based on the capture times of adjacent frames, a time interval based on the eye to which it will be displayed, or any other suitable time interval. For example, output frames can be displayed to both eyes at a characteristic frame rate (e.g., 30 fps, 60 fps, etc.). In this example, output frames can be displayed to the first eye at a high duty cycle (e.g., substantially unity, wherein a frame is displayed for substantially the entire frame time interval, such as 1/30 s for a 30 fps frame rate) and can be displayed to the second eye at a lower duty cycle (e.g., 50%, in which a frame is displayed for half the frame time interval, and an alternate signal such as a white or black frame is displayed for the other half). However, the frames can be displayed with any suitable timing.

### 2. Binocular Display System

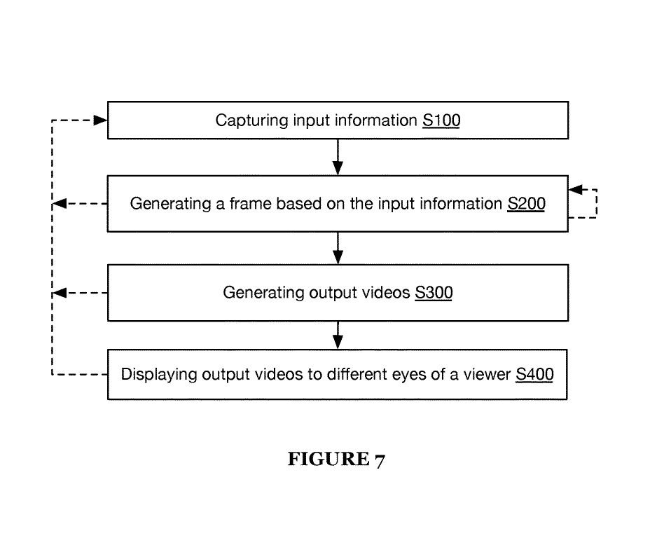

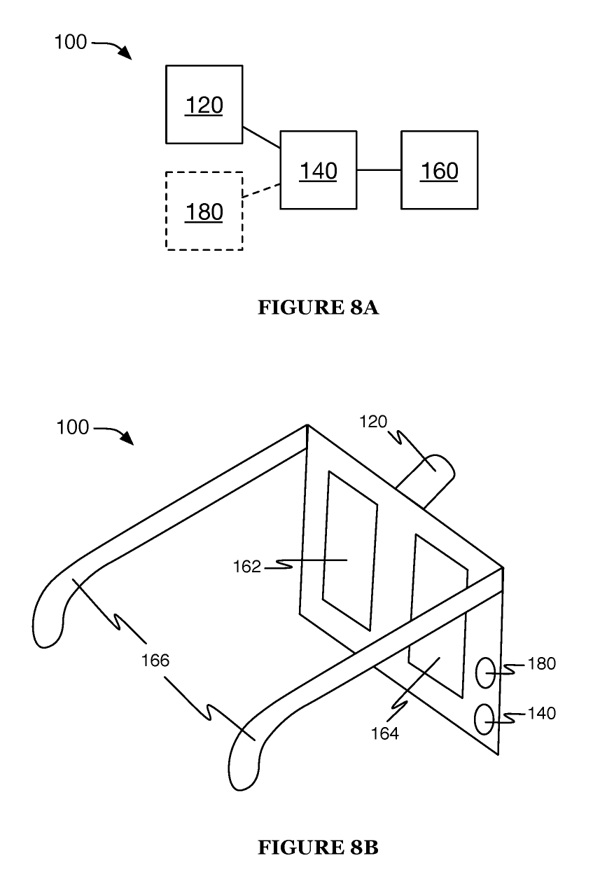

The binocular display 100 can include: a camera 120 adapted to capture an input video; a processor 140 adapted to receive information from the camera; and a display unit 160 adapted to receive information from the processor (e.g., as shown in FIGS. 8A-8B). The binocular display functions to enhance the sense of depth perceived by a viewer 200. The binocular display can preferably be used in such a way as to help create or enhance a stereoscopic or pseudo-stereoscopic effect.

The camera 120 functions to provide an input video to the processor 140. Possibly, the camera uses a digital image sensor such as a charge-coupled device or active-pixel image sensor, but alternately could use any suitable sensor or imaging medium for capturing the input video or any other images. In some embodiments, the binocular display also includes one or more additional cameras 122 adapted to provide information to the processor 140. Possibly, the additional cameras 122 are adapted to capture video, but alternately can only be adapted to capture still images at a rate lower than a video frame rate. In some variations, a single additional camera 122 can be arranged such that the camera 120 and the additional camera 122 can capture stereoscopic images. In a first example, the camera 120 and additional camera 122 can be arranged horizontally, separated by a distance similar to a typical human pupillary distance, and aimed in similar directions. In a second example, the camera 120 and several additional cameras 122 can be aimed substantially radially outward of a point or axis in a panoramic camera array 124, such that in combination they can be able to capture panoramic images (e.g., having a field of view similar to or greater than that of a typical human, having a 360° field of view, etc.).

The processor 140 can be configured to perform the method discussed above and/or to perform any other suitable set of processes. In one variation, the processor 140 generates two different videos: a first output video and a second output video. The first output video can include a sequence of generated frames, and each generated frame can be a spatially non-uniform mixture of a plurality of the frames of the input video. The processor 140 can perform the method (e.g., as described above); it can generate the first output video and second output video in any other suitable manner; and/or it can perform any other suitable function.

The display unit 160 can include: a first display area 162 adapted to display the first output video; a second display area 164 adapted to display the second output video; and a support 166 adapted to position the display unit such that the first display area 162 is visible to the first eye 220 of the viewer and the second display area 164 is visible to the second eye 240 of the viewer, in a manner suitable for binocular viewing. Possibly, the first display area 162 and second display area 164 are regions (e.g., non-overlapping, overlapping, a single region, etc.) of a single display, but alternately can be two separate displays. The support 166 can attach to the viewer 200 (e.g., with eyeglass temples, adhesive, a band, or any other suitable coupling mechanism), or alternately can support the display unit near the viewer 200. In a specific example, the support 166 is configured to couple to a user device (e.g., smart phone). The user device can include the first and second display areas 162, 164, the camera 120, the processor 140, and/or any other suitable elements of the binocular display 100, and can include a client configured to control the user device components (e.g., control the camera to capture video, control the processor to generate output videos, control the display areas to display the videos, etc., such as to perform the method). The display unit 160 can be: a headset, a television, a large-format display (e.g., simulated window), eyewear (e.g., goggles, glasses, contact lenses, etc.), or any other suitable structure. The display unit can include optical lenses (e.g., simple lens, compound lens, Fresnel lens, zone plate lens, etc.) and/or any other suitable optical elements.

In some variations, the binocular display 100 can include an inertial measurement sensor 180 adapted to provide information to the processor 140, such as an accelerometer or gyroscope. The inertial measurement sensor 180 can be mechanically connected to any of: the camera 120; an additional camera 122; the display unit 160; the viewer 200; or any other suitable element of the binocular display 100; or can alternatively not be mechanically connected to any other element of the binocular display 100.

In other variations, the processor 140 can be programmed to use motion-related data to control the generation of the generated frames. In a first variation, the motion-related data can be generated from the input video, such as based on estimated motion of objects depicted in the video or estimated motion of the camera used to capture the video. In a second variation, the motion-related data can be generated by an inertial measurement sensor 180. In a third variation, the binocular display 100 can include a panoramic camera array 124, and the images used by the processor 140 to generate the output videos can be selected such that the output videos appear to track the motion of an inertial measurement sensor 180.

The camera 120 is preferably mechanically connected to the binocular display too (e.g., to the display unit 160, any other suitable binocular display element) and/or the viewer 200, but can alternatively be mechanically separate. In some variations, the camera 120 can be configured to move (e.g., in response to motion of the viewer 200 or another element of the binocular display 100, possibly rotating in a substantially similar manner to the moving element; as controlled by the viewer 200 or another user; etc.). In a first example, the camera is a part of an endoscope (e.g., used to perform minimally invasive medical procedures such as arthroscopic or laparoscopic surgery). In a second example, the camera is attached to a vehicle (e.g., unmanned aerial vehicle, terrestrial robot, etc.). In a third example, the camera is attached to a rotatable mount at a tourist attraction. In alternate variations, the camera can remain fixed in place. Possibly, the camera is located near the display unit, but alternately, the camera can be located in any suitable location.

Although omitted for conciseness, the preferred embodiments include every combination and permutation of the various system components and the various method processes. Furthermore, various processes of the preferred method can be embodied and/or implemented at least in part as a machine configured to receive a computer-readable medium storing computer-readable instructions. The instructions are preferably executed by computer-executable components preferably integrated with the system. The computer-readable medium can be stored on any suitable computer readable media such as RAMs, ROMs, flash memory, EEPROMs, optical devices (CD or DVD), hard drives, floppy drives, or any suitable device. The computer-executable component is preferably a general or application specific processing subsystem, but any suitable dedicated hardware device or hardware/firmware combination device can additionally or alternatively execute the instructions.

The FIGURES illustrate the architecture, functionality and operation of possible implementations of systems, methods and computer program products according to preferred embodiments, example configurations, and variations thereof. In this regard, each block in the flowchart or block diagrams can represent a module, segment, step, or portion of code, which comprises one or more executable instructions for implementing the specified logical function(s). It should also be noted that, in some alternative implementations, the functions noted in the block can occur out of the order noted in the FIGURES. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

We claim:

1. A method for displaying images to a viewer, the method comprising:
receiving an input video;
automatically selecting a primary frame from the input video;
automatically selecting a delayed frame from the input video, the delayed frame preceding the primary frame;
automatically determining a blending mask comprising a plurality of pixels, wherein a pixel value of each pixel of the blending mask is determined based on a lightness of a corresponding pixel value of a frame of the input video;
automatically generating a generated frame, comprising, for each pixel of the blending mask, determining a pixel value of a corresponding pixel of the generated frame by averaging a corresponding pixel value of the primary frame with a corresponding pixel value of the delayed frame based on the pixel value of the pixel of the blending mask;
generating a first output video comprising the generated frame;
generating a second output video based on the input video, the second output video different from the first output video;
displaying the first output video to a first eye of the viewer; and
concurrent with displaying the first output video to the first eye of the viewer, displaying the second output video to a second eye of the viewer.

2. A method for displaying images to a viewer, the method comprising:
capturing a set of input information comprising an input video;
selecting a primary frame from the input video;
selecting a delayed frame from the input video, the delayed frame captured before the primary frame;
generating a generated frame by mixing the primary frame with the delayed frame in a spatially non-uniform manner;
generating a first output video comprising the generated frame;
generating a second output video based on the input video, the second output video different from the first output video;
displaying the first output video to a first eye of the viewer, wherein the generated frame is displayed substantially concurrent with the capture of the primary frame; and
concurrent with displaying the first output video to the first eye of the viewer, displaying the second output video to a second eye of the viewer.

3. The method of claim 2, wherein selecting the delayed frame comprises:
determining that an object is depicted by the primary frame; and
determining that the object is depicted by the delayed frame.

4. The method of claim 2, further comprising:
determining a control signal based on the input video; and
determining the spatially non-uniform manner based on the control signal.

5. The method of claim 4, wherein determining the control signal comprises performing an image segmentation process on a frame of the input video.

6. The method of claim 4, wherein:
the control signal comprises an image signal comprising a plurality of pixels; and
determining the control signal comprises determining a pixel of the control signal based on a corresponding pixel of a frame of the input video.

7. The method of claim 6, wherein the pixel of the control signal is determined based on a lightness of the corresponding pixel.

8. The method of claim 6, wherein:
determining the spatially non-uniform manner comprises determining a weighting based on the pixel of the control signal; and
mixing the primary frame with the delayed frame comprises averaging a pixel value of a corresponding pixel of the primary frame with a pixel value of a corresponding pixel of the delayed frame based on the weighting.

9. The method of claim 4, wherein:
mixing the primary frame with the delayed frame comprises additively blending the primary frame and the delayed frame based on a mask; and
the control signal comprises the mask.

10. The method of claim 2, further comprising, before selecting the delayed frame, determining a target delay time based on the set of input information, wherein a time interval between the capture of the delayed frame and the capture of the primary frame equals the target delay time.

11. The method of claim 10, wherein:
capturing the set of input information comprises sampling a set of acceleration data; and
the target delay time is determined based on the set of acceleration data.

12. The method of claim 10, further comprising determining a set of perceived motion data based on the input video, wherein the target delay time is determined based on the set of perceived motion data.

13. The method of claim 2, wherein:
displaying the second output video comprises displaying an output frame of the second output video to the second eye substantially concurrent with displaying the generated frame to the first eye;
the output frame is different from the generated frame; and
a difference metric between the output frame and the generated frame is less than a threshold difference.

14. The method of claim 13, wherein the primary frame is the output frame.

15. The method of claim 13, further comprising generating the output frame by mixing the primary frame with the delayed frame in a second spatially non-uniform manner.

16. The method of claim 15, wherein:
generating the generated frame comprises mixing the primary frame with the delayed frame based on a control signal; and
generating the output frame comprises mixing the primary frame with the delayed frame based on the control signal.

17. The method of claim 13, further comprising determining the threshold difference based on the set of input information.

18. A method for displaying images to a viewer using a user device including a camera and a display unit including a first and second display area, the method comprising, at a client of the user device, while the user device is coupled to the viewer:
controlling the camera to sample an input video;
generating an output frame by mixing a plurality of frames of the input video in a spatially non-uniform manner;
generating a first output video comprising the output frame;
generating a second output video based on the input video, the second output video different from the first output video;
controlling the display unit to display the first output video to a first eye of the viewer at the first display area; and
concurrent with displaying the first output video to the first eye of the viewer, displaying the second output video to a second eye of the viewer at the second display area.

19. The method of claim 18, further comprising generating a sequence of output frames, wherein:
generating the sequence of output frames comprises, for each output frame of the sequence, generating the respective output frame by mixing a respective plurality of frames of the input video in a respective spatially non-uniform manner; and
the first output video further comprises the sequence of output frames.

20. The method of claim 18, further comprising, at the client of the user device:
concurrent with controlling the camera to sample the input video, controlling an inertial measurement unit of the user device to sample a set of motion data; and
before generating the output frame, determining the spatially non-uniform manner based on the set of motion data.
